(19) United States
(12) Patent Application Publication
(10) Pub. No.: US 2002/0136385 A1
(43) Pub. Date: Sep. 26, 2002

(54) Method and apparatus for performing trunk selection

(76) Inventor: Dejian Zhou, Plano, TX (US)

Correspondence Address: Dan C. Hu, TROP, PRUNER & HU, P.C., Ste. 100, 8554 Katy Freeway, Houston, TX, 77024, US

(21) Appl. No.: 09/817,641

(22) Filed: Mar. 26, 2001

(51) Int. Cl. H04M 7/00

(52) U.S. Cl. 379/219; 379/224; 379/232

(57) ABSTRACT

A telephony network includes a number of switches that are coupled by respective trunk sets. In one or more of the switches, both a main queue storing identifiers of trunks that are available and a shadow queue are maintained. The shadow queue is used to store identifiers of available trunks in an order that tracks the order of a corresponding queue in a switch on the other end of the trunk set. By using both the contents of the main queue and the shadow queue to perform selection, trunk glare can be reduced.

### TECHNICAL FIELD

The invention relates to a method and apparatus for performing trunk selection.

### BACKGROUND

In conventional telephony networks, telephones are coupled to a switch, such as a switch located in a central office or end office, a tandem switch between end offices, a private exchange system (e.g., a private branch exchange or PBX system, a key telephone system, and so forth), and other types of switches. Signaling and data are exchanged between switches over a trunk.

A call initiated at a terminal is routed through one or more switches to the destination terminal. At each switch, a trunk is selected from a trunk group for processing the call. Trunks between switches are common resources used for establishing calls in both directions. An originating switch selects an idle trunk from available trunks to serve a call. After the call is established on the trunk, the switches on both ends mark the trunk as being “in use” so that the trunk will not be selected by another call. When a call is terminated on a trunk, switches on both ends mark the trunk as being “idle,” which allows the trunk to be used by another call.

Trunk glare occurs when a trunk is simultaneously selected for two calls originated on both switches, before the switches detect the trunk usage. If trunk glare occurs, one of the switches has to retry the trunk selection to find another available trunk for the call. The reselection process is typically time consuming and slows call initiation.

To reduce glare, various algorithms are used. Examples of such algorithms include an MIDL/LIDL (most idle/least idle) algorithm set, an ASEQ/DSEQ (ascending sequential/descending sequential) algorithm set, and a CWH/CCWH (clockwise circular trunk hunting/counter-clockwise circular trunk hunting) algorithm set. For example, if the MIDL/LIDL algorithm set is used, then a switch at one end of the trunk uses the MIDL algorithm while the switch at the other end of the trunk uses the LIDL algorithm. Similarly, for the ASEQ/DSEQ and CWH/CCWH algorithm sets, switches on different ends of a trunk uses different ones of the algorithms in each set (ASEQ on one switch and DSEQ on the other switch, CWH on one switch and CCWH on the other switch). The likelihood of glare is reduced by using different algorithms on the two ends of each trunk.

The MIDL algorithm has the benefit of selecting all trunks evenly, which reduces the likelihood that a faulty or noisy circuit is over-used. The LIDL algorithm is the opposite of the MIDL algorithm, and re-uses the same trunks over and over.

The ASEQ algorithm traverses a trunk member list in an ascending direction, while the DSEQ algorithm traverses the trunk member list in a descending order, both from a fixed starting point. Thus, the chance for trunk glare occurs when the trunk member list is down to its last free member.

The CWH and CCWH algorithms are similar to the ASEQ and DSEQ algorithms in that both sets are based on a fixed ordered list of trunks. As with the ASEQ/DSEQ method, the two switches at the two ends of a trunk using the CWH and CCWH algorithms search the list in opposite directions. The difference is that the CWH/CCWH searching start point is dynamic rather than fixed. The trunk selected is the first idle trunk found in a search starting after the most recently released trunk in the trunk member list.

However, even with use of such algorithms, the occurrence of trunk glare may be unacceptably high.

### SUMMARY

In general, according to one embodiment, a first switch system capable of communicating with a second switch system comprises a storage element to store information indicating at least one available trunk for originating a call with the second switch system. A controller is adapted to determine if the indicated at least one available trunk is likely to be used by the second switch for call origination. If the at least one available trunk is likely to be used by the second switch, the controller is adapted to select another trunk for all origination.

Some embodiments of the invention may have one or more of the following advantages. By keeping track of whether a given trunk is likely to be used by a switch on the opposite end of a trunk, selection of that trunk can be avoided or reduced so that the likelihood of trunk glare can be reduced. By reducing trunk glare, efficiency in setting up calls over a telephony network is improved.

Other or alternative features or advantages will become apparent from the following description, from the drawings, and from the claims.

### BRIEF DESCRIPTION OF THE DRAWINGS

FIG. 1 is a block diagram of a telephony system including a plurality of switches that are coupled by respective trunks.

FIG. 2 is a block diagram of queues used in some switches of FIG. 1.

FIG. 3 is a flow diagram of an operation performed by a trunk selection logic, according to an embodiment, in a switch of FIG. 2.

FIG. 4 illustrates an example shadow queue and a main queue used by the trunk selection logic of FIG. 3.

FIG. 5 is a block diagram of a switch according to an example arrangement.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

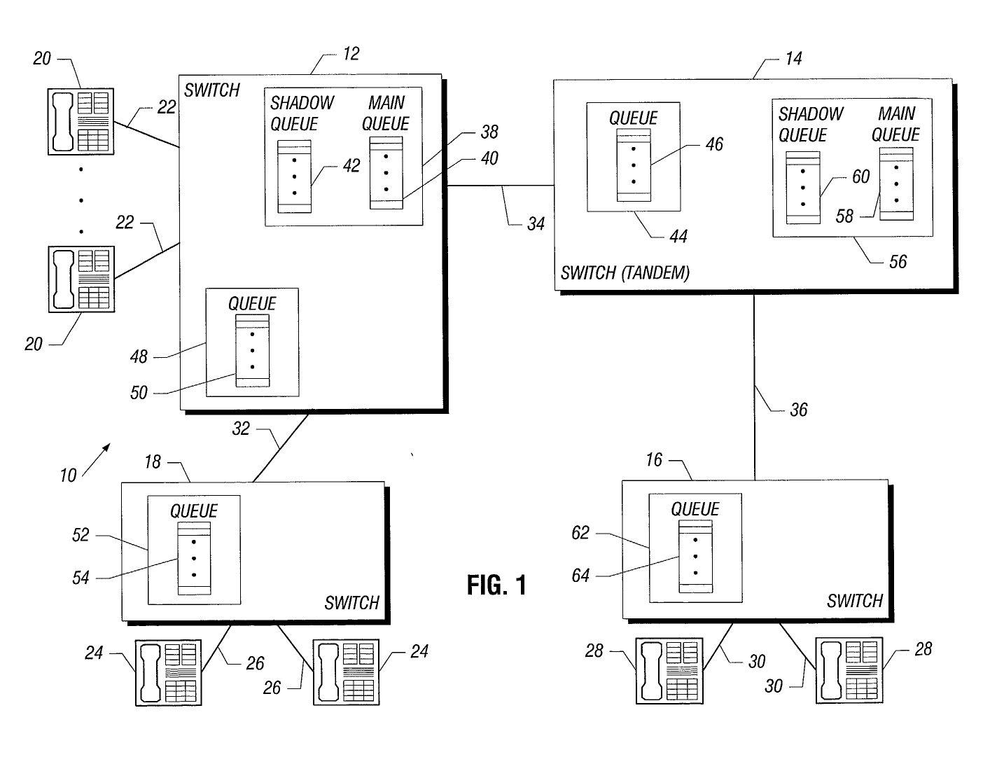

Referring to FIG. 1, a telephony network 10 includes a plurality of switches 12, 14, 16, and 18. The arrangement and number of switches shown in FIG. 1 is by way of example only, as other telephony networks may have other arrangements and numbers of switches. The switch 14 is a tandem switch that is connected between two switches 12 and 16. Switches can also be directly connected to each other without the use of a tandem switch, such as switches 12 and 18. The switches 12, 16 and 18 in one example are part of a central office or end office operated by a local exchange carrier (LEC). Alternatively, some or all of the switches 12, 14, 16 and 18 can be private exchange systems, such as private branch exchange (PBX) systems, key telephone systems, centrex systems, and so forth.

Telephone sets or other terminals 20 are coupled to the switch 12 over lines 22, telephone sets or other terminals 24 are coupled to the switch 18 over lines 26, and telephone sets or other terminals 28 are coupled to the switch 16 over lines 30. A pair of switches are coupled to each other over trunks. As used here, a set or group of trunks (“trunk set” or “trunk group”) connects a pair of switches. Thus, switches 12 and 18 are coupled by a trunk set 32, switches 12 and 14 are coupled by a trunk set 34, and switches 14 and 16 are coupled by a trunk set 36.

As used here, a “trunk” refers to any circuit or link between two or more switches. The term “trunk” refers to a circuit or link that is able to support the calling loads generated by a group of terminals. On the other hand, a “line” is typically a circuit or link between a telephone set or other terminal and a switch. For example, a trunk can be implemented with a T-carrier line (e.g., T1, T3, E1, etc.). Generally, a T1 line is a four-wire circuit that has 24 channels each having a bandwidth up to 64 kbps (kilobits per second), for a total bandwidth of about 1.536 Mbps (megabits per second). Thus, in one embodiment, a trunk can be considered a channel of a T-carrier line. Other types of trunks can be employed in other embodiments.

In accordance with some embodiments of the invention, a trunk selection algorithm is used to reduce the likelihood of trunk glare between each pair of switches in the telephony network 10 of FIG. 1. According to one embodiment, a shadow queue is maintained in some of the switches of the telephony network 10, with the shadow queue used to indicate trunk(s) that are likely to be used by the switch (referred to as “counterpart switch” or “opposing switch”) on the opposite end of the trunk(s). Thus, effectively, the shadow queue enables a switch to track trunk(s) that are likely to be used by the opposing switch. By using the tracking information, a trunk for a new call in the originating switch can be selected to avoid possible conflict with selection of the same trunk by the opposing switch (which results in trunk glare). The tracking information is built locally from call termination events; as a result, messaging between switches for such information is not required in some embodiments.

Some embodiments of the invention provide superior performance in reducing trunk glare by using tracking information of trunk selection in an opposing switch. In other embodiments, instead of a shadow queue, other mechanisms for tracking trunk selection in an opposing switch can be employed. Although not excluded from the scope of the invention, the tracking of likely trunk selection in the opposing switch is performed without exchanging information regarding trunk selection between the switches. In one embodiment, the tracking can be performed using knowledge of the trunk selection algorithm in the opposing switch, as well as knowledge of selection and release of trunks in calls involving the switch in which the trunk selection logic is located.

As generally shown in FIG. 1, the switch 12 includes a trunk selection control module 38 that has a main queue 40 and a shadow queue 42. The main queue 40 contains identifiers of trunks that are available for selection when a new call is originated. The shadow queue 42 contains identifiers of trunks arranged in an order to match the order of trunk identifiers in the queue 46 of the opposing switch 14. The trunk selection control module 38 is associated with the trunk set 34. Trunk selection performed by the trunk selection control module 38 is based on conventional trunk selection algorithms as well as the shadow queue. In the switch 14 on the other end of the trunk set 34, a trunk selection control module 44 includes a queue 46 containing identifiers of available trunks in the trunk set 34. In accordance with some embodiments, a shadow queue is needed only in a switch on one end of a given trunk set. Thus, in the example of FIG. 1, the trunk selection control module 38 tracks trunk selection by the trunk selection control module 44 in opposing switch 14, but not vice versa.

The switch 12 also includes another trunk selection control module 48 that includes a queue 50 to indicate available trunks of the trunk set 32. On the other end of the trunk set 32, a trunk selection control module 52 in the switch 18 includes a queue 54. In the example of FIG. 1, the trunk selection control modules 48 and 52 do not use a shadow queue, but instead, use conventional trunk selection algorithms, such as MIDL/LIDL (most idle/least idle), ASEQ/DSEQ (ascending sequential/descending sequential), and CWH/CCWH (clockwise circular trunk hunting/counter-clockwise circular trunk hunting) algorithms.

The tandem switch 14 also includes a trunk selection control module 56 for the trunk set 36. The trunk selection control module 56 includes a main queue 58 and a shadow queue 60. The switch 16 on the other end of the trunk set 36 includes a trunk selection control module 62 having a queue 64.

Thus, in the example of FIG. 1, embodiments of the invention can be used to reduce trunk glare between switches 12 and 14 and between switches 14 and 16. However, embodiments of the invention are not employed on the trunk set 32 between switches 12 and 18.

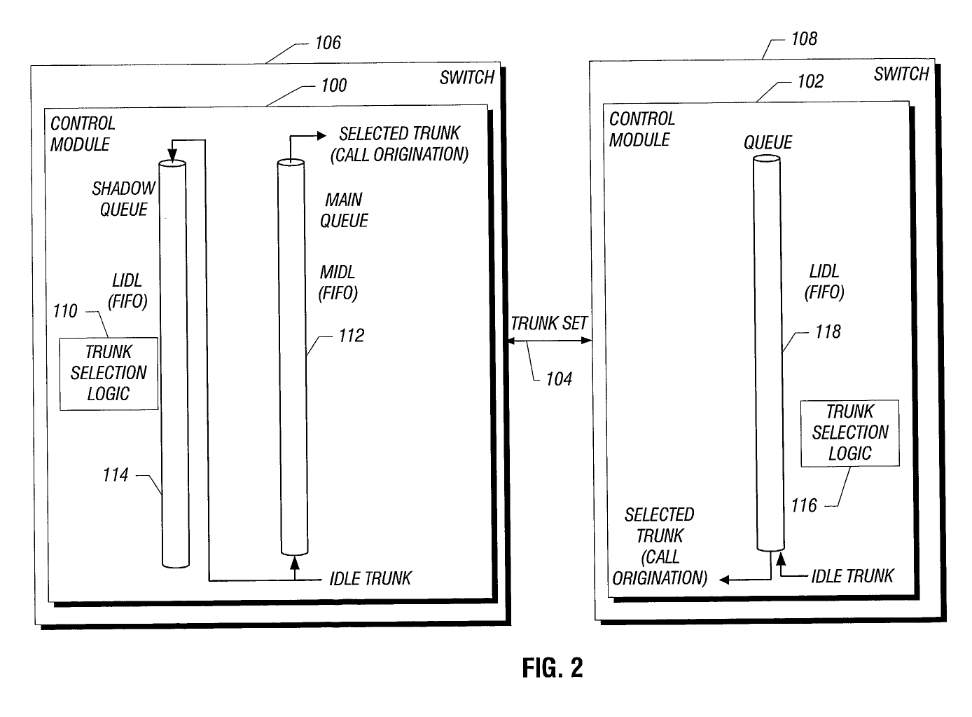

Referring to FIG. 2, an example arrangement of trunk selection control modules 100 and 102 in two example switches 106 and 108 coupled by a trunk set 104 is illustrated. Each trunk selection control module and switch shown in FIG. 2 represents a respective trunk selection control module and switch in FIG. 1. The trunk selection control module 100 includes trunk selection logic 110, a main queue 112, and a shadow queue 114. The trunk selection control module 102 includes trunk selection logic 116 and a queue 118. The trunk selection logic 110 and 116 can be implemented as software, hardware, or a combination of both. Trunk selection is performed by the trunk selection logic 110 and 116 is based on a conventional trunk selection algorithm, such as MIDL/LIDL, ASEQ/DSEQ, or CWH/CCWH, and also on a shadow queue (if present).

The queues 112, 114, and 118 are stored in storage devices (e.g., memory, hard disk, etc.) in respective switches 106 and 108. In accordance with one embodiment, the main queue 112 uses an MIDL algorithm, while the queue 118 in the other switch 108 uses an LIDL algorithm. To track the LIDL queue 118, the shadow queue 114 in the first switch 106 is also an LIDL queue. To implement the MIDL queue 112, the queue 112 is configured as a first-in-first-out (FIFO) buffer, while the LIDL queues 114 and 118 are configured as first-in-last-out (FILO) buffers.

In an alternative embodiment, the main queue 112 in the switch 106 can be configured as an LIDL queue, while the shadow queue 114 and the queue 118 in the opposing switch 108 are configured as MIDL queues. In yet other embodiments, instead of using the MIDL/LIDL algorithms, the ASEQ/DSEQ, CWH/CCWH, or other trunk selection algorithms can be employed.

The main queue 112 includes identifiers of trunks that are available for selection in response to a call origination. According to the MIDL algorithm, a trunk is selected from one end of the queue 112 while a released trunk is returned to the other end of the queue 112. When selected, a trunk identifier is removed from the queue 112 and shadow queue 114. When a call terminates on a trunk, the identifier of the idle trunk is returned to the queue 112 and shadow queue 114. In the second switch 108, the LIDL FILO queue 118 selects a trunk from a first end (illustrated as the bottom end) of the queue 118, while an identifier of a released trunk (on which a call has terminated) is returned also to the first end of the queue 118. Thus, using the LIDL algorithm, it is the trunks near the first end of the queue 118 that are most likely to be selected.

The shadow queue 114, also configured as a LIDL FILO, is used to track the queue 118 in the second switch 108. In accordance with some embodiments, this is performed without an exchange of information between the trunk selection control modules 100 and 102. The shadow queue 114 also contains a list of identifiers of available trunks. When a trunk is selected by the control module 100, the identifier of the selected trunk is removed from the shadow queue 114 (as well as from the main queue 112). When a call is released, the identifier of the idle trunk is returned to the top end of the shadow queue 114, while the identifier of the idle trunk is returned to the bottom end of the main queue 112 in the first switch 106 and also to the bottom end of the LIDL queue 118 in the second switch 108. Note that use of the terms “top end” and “bottom end” are provided for ease of explanation, as the designations can be reversed. Further, in other embodiments, instead of selecting trunk identifiers from and returning trunk identifiers to ends of a queue, the selection and return of trunk identifiers can be performed from and to other locations of the queue (which may be the case if ASEQ/DSEQ or CWH/CCWH algorithms were used, for example).

The trunk selection logic 110 uses information in the shadow queue 114 to perform a determination of whether there is likely conflict in selection of a trunk from the top of the MIDL queue 112. Effectively, the trunk selection logic 110 is able to determine what trunks are likely to be selected by the trunk selection logic 116 in the second switch 108, and to avoid selecting such trunks from the MIDL queue 112 in the first switch 106.

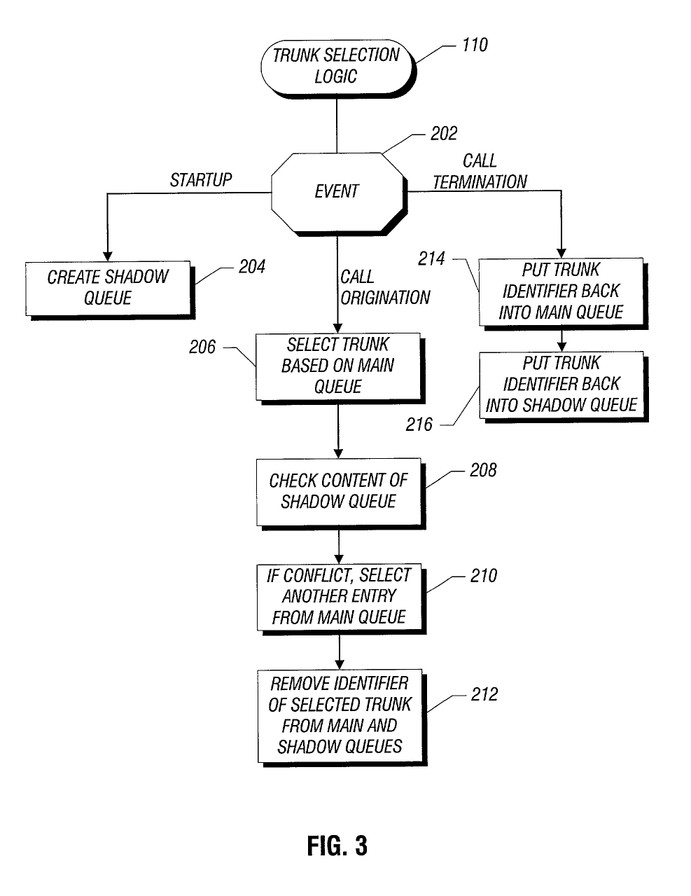

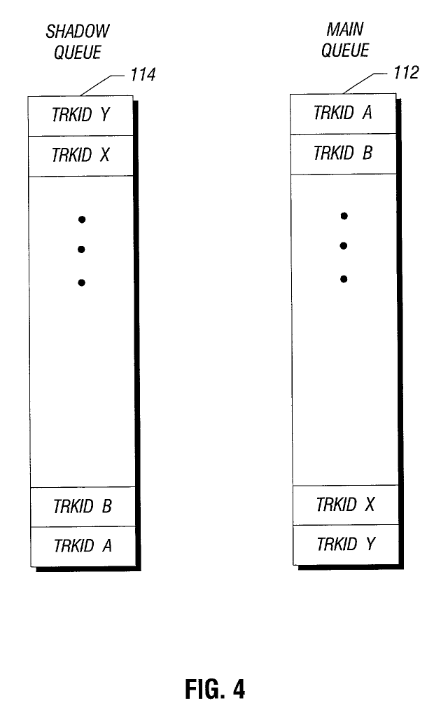

Referring to FIG. 3, some of the acts performed by the trunk selection logic 110 in accordance with one embodiment are illustrated. The trunk selection logic 110 waits for occurrence of an event (at 202). If the event is a startup event, then a shadow queue is created (at 204). In the example of FIG. 2, where the main queue is a MIDL queue and the shadow queue is an LIDL queue, the content of the shadow queue is the reverse of the MIDL queue. In other words, the identifiers of available trunks are stored in a first order in the MIDL queue, while the identifiers of the available trunks are stored in opposite order in the shadow queue. This is illustrated in FIG. 4, where trunk IDs TRKID A-Y are stored in a first order (from A to Y) in the main queue 112, while the same trunk IDs TRKID A-Y are stored in an opposite order (from Y to A) in the shadow queue 114.

It is noted that, initially at startup, the content of the shadow queue 114 can be quite different from the content of the queue 118 in the second switch 108 (which the shadow queue 114 is supposed to track). However, after a number of calls equal to the number of entries in each of the queues 114 and 118 (which in turn is equal to the number of trunks in trunk set) have terminated, then the contents of the shadow queue 114 and queue 118 will become close to or the same due to the FILO rule.

After startup and creation of the shadow queue, the trunk selection logic 110 waits for either a call origination event or a call termination event. If a call origination event is received, then the trunk selection logic 110 selects (at 206) a trunk based on an algorithm used in the main queue 112. Thus, in the case of a MIDL queue, the selected trunk is from the top of the queue 112. The trunk selection logic 110 then checks (at 208) the content of the shadow queue 114. The check compares the top entry of the main queue 112 with the top entry of the shadow queue 114. If the values are equal, then that indicates that a conflict is likely to occur, and the trunk selection logic 110 selects (at 210) another entry from the main queue 112. In one example, this other entry is the second entry from the top of the main queue 112. In other embodiments, other alternate entries from the main queue 112 can be selected. The identifier of the selected trunk is then removed from the main and shadow queues (at 212).

When the trunk selection logic 110 receives a call termination event (at 202), indicating that a trunk has been released, the trunk selection logic 110 puts (at 214) the identifier of the released trunk or idle trunk back into the main queue 112. In the MIDL example, the idle trunk identifier is returned to the bottom of the queue 112. The trunk selection logic 110 also puts (at 216) the trunk identifier back into the shadow queue 114. In the LIDL shadow queue example, the idle trunk identifier is returned to the top of the shadow queue 114.

To originate a call, a first switch (e.g., switch 106) selects a trunk (using the enhanced trunk selection algorithm described here) and sends a call origination request to a second switch (e.g., switch 108) over the selected trunk by using PTS (per-trunk signaling, or in-band signaling) or CCS7 (common channel signaling 7) signaling. For example, the call origination request can include an ISDN (Integrated Services Digital Network) user part (ISUP) message, such as the IAM (initial address message), which contains an originating point code, destination point code, dialed digits, and other information. Upon receiving the IAM (or other call origination request message), the second switch 108 knows that the requested trunk is reserved and unavailable (and thus is removed from the trunk selection queue 118).

To terminate a call (from the second switch 108), the second switch sends a release message (e.g., REL), which indicates to the trunk selection logic in the first switch 106 that a trunk has become idle again.

Thus, by locally keeping track of information pertaining to a trunk selection queue of an opposing switch, a switch is able to avoid selection of a trunk that is likely to be selected by the opposing switch, thereby reducing the likelihood of trunk glare. As noted above, this can be achieved by building the tracking information locally, without exchanging information with the opposing switch.

An underlying theory behind the enhanced algorithm according to some embodiments is that a call arriving process on the opposing switch (e.g., switch 108 in FIG. 2) is a Poisson process. In a Poisson process, the probability of two arrivals (receipt of two call origination requests) at the same time is zero. Thus, when skipping from a first entry of the MIDL queue to a second (or some other) entry in the MIDL queue, the Poisson process guarantees that the opposing switch will not use the second (or other) trunk for the call at this time. Also, to avoid trunk glare when the MIDL queue 112 is down to its last available member, trunk selection can be blocked in the switch 106.

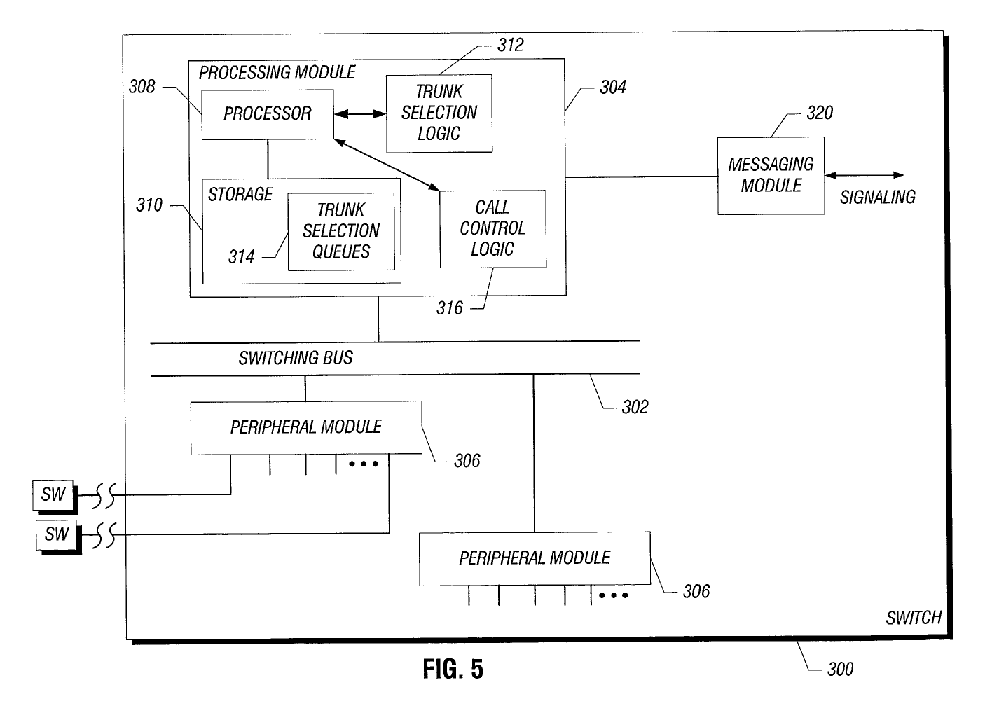

Referring to FIG. 5, a switch 300 according to one example is illustrated. The arrangement of the switch 300 is provided as an example only and is not intended to limit the scope of the invention. Many other arrangements of switches can be employed in other embodiments. The switch 300 can be used as any of the switches 12, 14, 16, or 18 in FIG. 1.

The switch 300 includes a switching bus 302 that is coupled to various components, including a processing module 304 and a plurality of peripheral modules 306. The peripheral modules 306 shown in FIG. 5 are connected to trunks that are connected to one or more other switches. In the example shown, one peripheral module 306 is connected to plural switches. In another embodiment, one peripheral module 306 can be connected to one switch. Although not shown, another peripheral module may be present in the switch 300 for connection to lines, with the lines coupled to remote terminals, such as telephone sets.

The processing module 304 includes one or more processors 308, as well as storage 310. The storage 310 can include main memory, magnetic media, and/or optical media. Trunk selection logic 312 (which can be the trunk selection logic 110 or 116 of FIG. 2) is executable as a software routine (or plural software routines) in the processing module 304. The trunk selection logic 312 is executable on the one or more processors 308. The trunk selection logic 312 has access to the trunk selection queue(s) 314 that are contained in the storage 310. The trunk selection queue(s) 314 include a shadow queue in some implementations. The processing module 304 also includes call control logic 316, which can also be implemented as software executable on the one or more processors 308. To perform signaling with another switch, the processing module 304 is connected to a messaging module 320, which exchanges signaling on an out-of-band signaling link to other switches. An example of an out-of-band network is the Signaling System No. 7 (SS7) network. If in-band signaling is used instead, the processing module 304 sends messages to other switches through the peripheral module 306.

The various systems discussed herein each includes various software layers, routines, or modules. Such software layers, routines, or modules are executable on corresponding control units or processors. Each control unit or processor includes a microprocessor, a microcontroller, a processor card (including one or more microprocessors or microcontrollers), or other control or computing devices. As used here, a “controller” refers to a hardware component, software component, or a combination of the two. Although referred to in the singular, a “controller” can include plural software components, hardware components, or a combination thereof.

The storage devices referred to in this discussion include one or more machine-readable storage media for storing data and instructions. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Instructions that make up the various software routines, modules, or layers in the various systems are stored in respective storage devices. The instructions when executed by a respective control unit or processor cause the corresponding system to perform programmed acts.

The instructions of the software routines, modules, or layers are loaded or transported to each system in one of many different ways. For example, code segments including instructions stored on floppy disks, CD or DVD media, a hard disk, or transported through a network interface card, modem, or other interface device are loaded into the device or system and executed as corresponding software routines, modules, or layers. In the loading or transport process, data signals that are embodied in carrier waves (transmitted over telephone lines, network lines, wireless links, cables, and the like) communicate the code segments, including instructions, to the device or system. Such carrier waves are in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A first switch system capable of communicating with a second switch system, comprising:
a storage element to store information indicating at least one available trunk for originating a call with the second switch system; and
a controller adapted to determine if the indicated at least one available trunk is likely to be used by the second switch for call origination, and
if the at least one available trunk is likely to be used by the second switch, the controller adapted to select another trunk for call origination.

2. The first switch system of claim 1, wherein the storage element comprises a main queue and a shadow queue, the main queue to store identifiers of available trunks and the shadow queue to store identifiers arranged in an order to track storage of identifiers of available trunks in the second switch.

3. The first switch system of claim 2, wherein the main queue is adapted to use one of a most idle (MIDL) algorithm and a least idle (LIDL) algorithm that is a counterpart of the other one of the MIDL algorithm and LIDL algorithm for a queue in the second switch.

4. The first switch system of claim 2, wherein the main queue and shadow queue are adapted to employ different algorithms for storing identifiers of available trunks.

5. The first switch system of claim 4, wherein the controller is adapted to select one trunk for a call origination, the controller adapted to remove an identifier of the one trunk from the shadow queue and the main queue.

6. The first switch system of claim 5, wherein the controller is adapted to return an identifier of a released trunk to the shadow queue and the main queue.

7. The first switch system of claim 6, wherein the controller is adapted to return the identifier of the released trunk to a first end of the main queue and to an opposite end of the shadow queue.

8. The first switch system of claim 7, wherein the controller is adapted to select the one trunk from a first entry of the main queue, the controller adapted to further compare an identifier in the first entry with a corresponding entry in the shadow queue to determine if one first trunk is likely to be selected by the second switch.

9. The first switch system of claim 2, wherein the main queue is adapted to use one of an ascending sequential (ASEQ) algorithm and descending sequential (DSEQ) algorithm that is a counterpart of the other one of the ASEQ algorithm and DSEQ algorithm for a queue in the second switch.

10. The first switch of claim 2, wherein the main queue is adapted to use one of a clockwise circular trunk hunting (CWH) algorithm and a counter-clockwise circular trunk hunting (CCWH) algorithm that is a counterpart of the other one of the CWH algorithm and CCWH algorithm for a queue in the second switch.

11. The first switch system of claim 1, the storage element further to store information for tracking trunk selection in the second switch.

12. The first switch system of claim 11, wherein the controller is adapted to use a first algorithm for selecting a trunk that is a counterpart of a second, different algorithm for selecting a trunk in the second switch.

13. The first switch system of claim 12, wherein the first algorithm is selected from the group consisting of the MIDL, LIDL, ASEQ, DSEQ, CWH, CCWH algorithms.

14. An article comprising at least one storage medium containing instructions that when executed cause a first switch system to:
maintain a first queue containing identifiers of available trunks;
arrange the identifiers of the first queue in a first arrangement;
maintain a second queue containing the identifiers of available trunks;
arrange the identifiers of the second queue in a second, different arrangement; and
select a trunk in response to a call origination based on the first and second queues.

15. The article of claim 14, wherein the instructions when executed cause the first switch system to arrange the identifiers of the second queue in the second arrangement that is consistent with an arrangement of a queue in a second switch system coupled to the first switch system over a set of trunks.

16. The article of claim 15, wherein the instructions when executed cause the first switch system to select the trunk by comparing an entry of the first queue with an entry of the second queue to determine if a conflict is likely with the second switch system.

17. The article of claim 16, wherein the instructions when executed cause the first switch system to further remove an identifier of a selected trunk from the first and second queues.

18. The article of claim 17, wherein the instructions when executed cause the first switch system to further return an identifier of a released trunk to a first end of the first queue and to an opposite end of the second queue.

19. The article of claim 14, wherein the instructions when executed cause the first switch system to arrange the identifiers of the first queue using one of an MIDL arrangement and LIDL arrangement and to arrange the identifiers of the second queue using the other one of the MIDL and LIDL arrangements.

20. The article of claim 14, wherein the instructions when executed cause the first switch system to arrange the identifiers of the first queue using one of an ASEQ arrangement and DSEQ arrangement and to arrange the identifiers of the second queue using the other one of the ASEQ and DSEQ arrangements.

21. The article of claim 14, wherein the instructions when executed cause the first switch system to arrange the identifiers of the first queue using one of an CWH arrangement and CCWH arrangement and to arrange the identifiers of the second queue using the other one of the CWH and CCWH arrangements.

22. A method of selecting a circuit for call origination between a first switch and a second switch, comprising:
maintaining a first list of available circuits in the first switch;
tracking a second list of available circuits in the second switch; and
selecting a circuit for call origination based on the first list and the tracking of the second list.

23. The method of claim 22, wherein tracking the second list is performed without communicating information regarding the second list from the second switch to the first switch.

24. The method of claim 22, wherein tracking the second list is performed locally in the first switch without knowledge of a content of the second list.

25. The method of claim 22, further comprising using an algorithm for updating the first list that is different than an algorithm for the second list.

26. The method of claim 22, wherein maintaining the first list comprises providing a first queue and tracking the second list comprises providing a shadow queue.

27. The method of claim 26, further comprising removing an identifier of a selected circuit from the first queue and the shadow queue.

28. The method of claim 27, further comprising returning an identifier of a released circuit to the first queue and the shadow queue.

29. A data signal embodied as a carrier wave and comprising instructions that when executed cause a system to:
maintain a first list of available trunks in a first switch;
track a second list of available trunks in a second switch coupled to the first switch over a set of trunks; and
select a trunk for call origination in the first switch using the first list and tracking of the second list.

29. A first switch system capable of communicating with a second switch system over a set of trunks, comprising:
a first queue containing identifiers of trunks available for originating a call with the second switch system;
a shadow queue containing identifiers of trunks available for originating a call with the second switch system, the identifiers of the first queue arranged according to a first algorithm and the identifiers of the shadow queue arranged according to a second, different algorithm; and
trunk selection logic adapted to select an available trunk using the first queue and the shadow queue, the trunk selection logic adapted to access the shadow queue to determine if a selected trunk from the first queue is likely to be used by the second switch for call origination, and
if the available trunk is likely to be used by the second switch, the controller adapted to select another trunk for call origination.
